(19) United States
(12) Patent Application Publication
(10) Pub. No.: US 2026/0336704 A1
(43) Pub. Date: Oct. 29, 2026

(54) VEHICLE REAR SKELETON STRUCTURE

(71) Applicant: TOYOTA JIDOSHA KABUSHIKI KAISHA, Toyota-shi (JP)

(72) Inventors: Norihiro MURASHIGE, Nisshin-shi (JP); Takehiro ITO, Nisshin-shi (JP); Tetsuo NURUKI, Toyota-shi (JP)

(73) Assignee: TOYOTA JIDOSHA KABUSHIKI KAISHA, Toyota-shi (JP)

(21) Appl. No.: 19/537,771

(22) Filed: Feb. 12, 2026

(30) Foreign Application Priority Data
Apr. 24, 2025 (JP) 2025-072737

(51) Int. Cl. B62D 21/11; B62D 25/08

(52) U.S. Cl. CPC B62D 21/11; B62D 25/08

(57) ABSTRACT

The vehicle rear skeleton structure is integrally formed by casting, and includes a rear skeleton body portion including a wheel house portion, and a strainer portion integrally formed with the rear skeleton body portion and extending from an upper portion of the wheel house portion in the vehicle vertical direction toward the vehicle upper side and having an upper end joined to a roof side rail or a pillar.

### CROSS-REFERENCE TO RELATED APPLICATION

This application claims priority to Japanese Patent Application No. 2025-072737 filed on Apr. 24, 2025. The disclosure of the above-identified application, including the specification, drawings, and claims, is incorporated by reference herein in its entirety.

### BACKGROUND

1. Technical Field

The present disclosure relates to a vehicle rear skeleton structure.

### 2. Description of Related Art

Japanese Unexamined Patent Application Publication No. 2024-117583 (JP 2024-117583 A) discloses a vehicle rear skeleton structure including a pair of right and left wheel houses and integrally molded by casting.

### SUMMARY

In the vehicle rear skeleton structure described above, when a side member portion is not appropriately axially compressed and rises at the time of a collision, a wheel house portion rises, and therefore there is room for improvement in the rigidity of the entire vehicle rear skeleton structure. In addition, when a strainer is joined to a member member, the strength of the joint portion may be lowered, and there is room for improvement in strength.

The present disclosure has been made in view of the above circumstances, and provides a vehicle rear skeleton structure capable of increasing rigidity and strength.

A first aspect of the present disclosure provides a vehicle rear skeleton structure including:
a rear skeleton body portion integrally fabricated by casting and including a wheel house portion; and
a strainer portion integrally fabricated with the rear skeleton body portion and extending from an upper portion of the wheel house portion in a vehicle up-down direction toward a vehicle upper side, an upper end of the strainer portion being joined to a roof side rail or a pillar.

In the above vehicle rear skeleton structure, the strength can be increased by integrally forming the rear skeleton body portion and the strainer portion. In addition, when the wheel house portion rises as the side member portion rises, the upper end of the strainer portion is pushed by the roof side rail or the pillar. As a result, the entire wheel house portion is pushed down, suppressing the rise of the wheel house portion. Accordingly, the rigidity of the entire vehicle rear skeleton structure can be increased.

In the vehicle rear skeleton structure according to the first aspect, the strainer portion may support an upper end portion of a shock absorber.

In the vehicle rear skeleton structure described above, the strainer portion supports the upper end portion of the shock absorber, and thus an input load input to the upper end portion of the wheel house portion through the upper end portion of the shock absorber can be distributed and received by the strainer portion.

In the vehicle rear skeleton structure according to the first aspect, both end portions of the strainer portion in a vehicle front-rear direction may extend continuously from both end portions of the wheel house portion in the vehicle front-rear direction.

In the vehicle rear skeleton structure described above, both end portions of the strainer portion in the vehicle front-rear direction extend continuously from both end portions of the wheel house portion in the vehicle front-rear direction, and thus the load can be smoothly transmitted between the strainer portion and the wheel house portion.

As described above, according to the vehicle rear skeleton structure of the present disclosure, rigidity and strength can be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a vehicle rear skeleton structure according to a first embodiment;

FIG. 2 is a perspective view showing details of the strainer portion of FIG. 1;

FIG. 3 is a perspective view illustrating details of a strainer portion of the vehicle rear skeleton structure according to the second embodiment;

FIG. 4 is a side view schematically illustrating a vehicle rear skeleton structure according to the first embodiment; and

FIG. 5 is a perspective view schematically showing a modification of the attachment position of the strainer portion of FIG. 2.

### DETAILED DESCRIPTION OF EMBODIMENTS

### First Embodiment

Hereinafter, a vehicle to which the vehicle rear skeleton structure 10 according to the first embodiment of the present disclosure is applied will be described with reference to the drawings. In the present specification and the drawings, constituent elements having substantially the same functional configuration are denoted by the same reference numerals, and redundant description thereof will be omitted. Further, an arrow FR appropriately shown in the drawings indicates a front side in the vehicle front-rear direction, and an arrow UP indicates an upper side in the vehicle up-down direction. The arrow LH indicates the left side in the vehicle width direction, and the arrow RH indicates the right side in the vehicle width direction, and in the present embodiment, indicates the vehicle width direction outer side. Hereinafter, in the case of simply describing the front-rear direction, the up-down direction, the left-right direction, and the inner-outer direction, unless otherwise specified, it is assumed that the front-rear direction of the vehicle front-rear direction, the up-down direction of the vehicle up-down direction, the left-right direction of the vehicle left-right direction (vehicle width direction), and the inner-outer side of the vehicle width direction are indicated.

Note that, unless otherwise specified in the specification, each element is not limited to one, and a plurality of elements may be present. In addition, in the drawings, substantially the same elements are denoted by the same reference numerals, and redundant description in the specification is omitted.

The vehicle to which the vehicle rear skeleton structure 10 according to the first embodiment is applied includes, for example, a power unit including a motor, an engine, or the like as a drive source, and is a battery electric vehicle and a fuel cell electric vehicle that travel with power generated by the power unit.

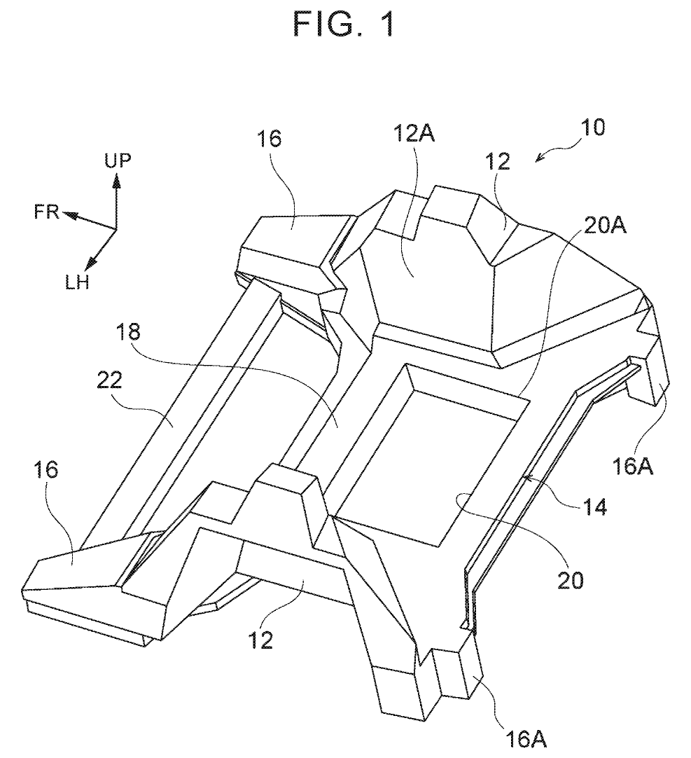

FIG. 1 is a perspective view schematically showing a vehicle rear skeleton structure 10 according to a first embodiment. In FIG. 1, the detailed shape of the vehicle rear skeleton structure 10 is illustrated in a simplified manner as appropriate. The vehicle rear skeleton structure 10 as the skeleton portion of the vehicle shown in FIG. 1 is provided at the rear portion of the vehicle. The vehicle rear skeleton structure 10 is integrally molded by casting.

As shown in FIG. 1, the vehicle rear skeleton structure 10 includes a pair of left and right wheel house portions 12, a floor portion 14 provided between the pair of left and right wheel house portions 12 and serving as a floor portion of the vehicle rear portion, and a rear skeleton body portion 11 including a side member portion 16 extending from the pair of left and right wheel house portions 12 to the vehicle front and rear.

The vehicle rear skeleton structure 10 includes a strainer portion (also referred to as a brace) 13 at an upper portion of a pair of left and right wheel house portions 12. The strainer portion 13 extends in the vehicle upward direction from an inner side surface 12A of the wheel house portion 12 in the vehicle widthwise direction. The strainer portion 13 is formed in an open cross-sectional shape having an opening on the outside in the vehicle width direction. The strainer portion 13 will be described in detail later.

The floor portion 14 includes a floor base 18 extending in the vehicle front-rear direction and the vehicle width direction. A wheel house portion 12 is disposed at both left and right end portions of the floor base 18. A substantially rectangular opening portion 20 that penetrates the floor base 18 in the vertical direction is provided at a substantially central portion in the vehicle front-rear direction and the vehicle width direction. A floor panel (not shown) is disposed in the opening portion.

A pair of left and right side member portions 16 are provided, and each side member portion extends in the front-rear direction from the front end to the rear end of the vehicle rear skeleton structure 10. Further, the front end portion of the side member portion 16 is connected by a connecting portion 22 extending in the vehicle width direction. Therefore, the front portion of the vehicle rear skeleton structure 10 is formed in a substantially frame shape by the floor base 18, the side member portion 16, and the connecting portion 22. The side member portion 16 includes a rear side member portion 16A extending from the wheel house portion 12 toward the rear of the vehicle. A bumper reinforcement (not shown) is attached to a rear end portion of the rear side member portion 16A.

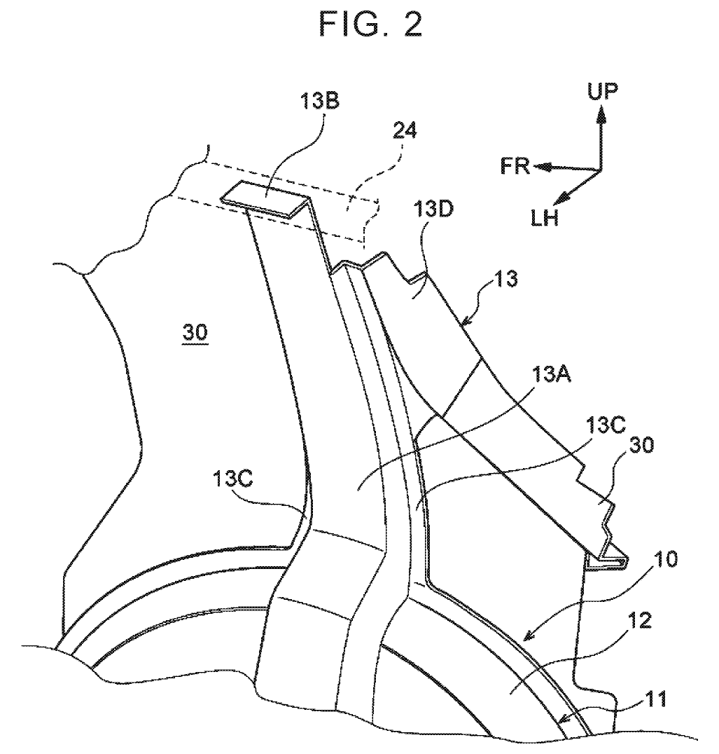

FIG. 2 is a perspective view showing details of the strainer portion 13 of FIG. 1. The strainer portion 13 extends upward from an upper portion of the wheel house portion 12. The strainer portion 13 includes a main body portion 13A that is open on the outer side in the vehicle-width direction and extends upward. The main body portion 13A is curved inward in the vehicle-width direction. The main body portion 13A includes, at an upper end thereof, an upper flange portion 13B bent inward in the vehicle-width-direction. The upper flange portion 13B is joined to the roof side rail 24 of the vehicle. The bonding method may be, for example, fastened by a bolt or the like, or a known method can be used.

Further, the main body portion 13A includes a lower flange portion 13C extending in the vehicle front-rear direction from an outer end portion of the main body portion 13A on both sides in the vehicle front-rear direction. Further, the lower flange portion 13C includes a mounting portion 13D extending outward in the vehicle-width direction. The lower flange portion 13C and the mounting portion 13D are joined to the shear panel 30 disposed on the vehicle-width-direction outer side of the wheel house portion 12. The shear panel 30 is disposed on the vehicle width direction outer side of the upper portion of the wheel house portion 12. In the present embodiment, the shear panel 30 functions as a load-bearing wall.

The vehicle rear skeleton structure 10 configured as described above is integrally molded by casting including a rear skeleton body portion 11, that is, a pair of left and right wheel house portions 12, a floor portion 14 (a floor base 18, an opening portion 20), a side member portion 16, a connecting portion 22, and a strainer portion 13.

### Operations and Effects

Next, the operation and effect of the first embodiment will be described.

In the vehicle rear skeleton structure 10 according to the first embodiment, the strength can be increased by integrally forming the rear skeleton body portion 11 and the strainer portion 13. Further, when the rear side member portion 16A rises at the time of the rear collision, when the wheel house portion 12 rises, the upper end of the strainer portion 13 is pushed by the roof side rail 24 to push down the entire wheel house portion 12, it is possible to suppress the rise of the wheel house portion 12. Accordingly, the rigidity of the entire vehicle rear skeleton structure 10 can be increased.

### Second Embodiment

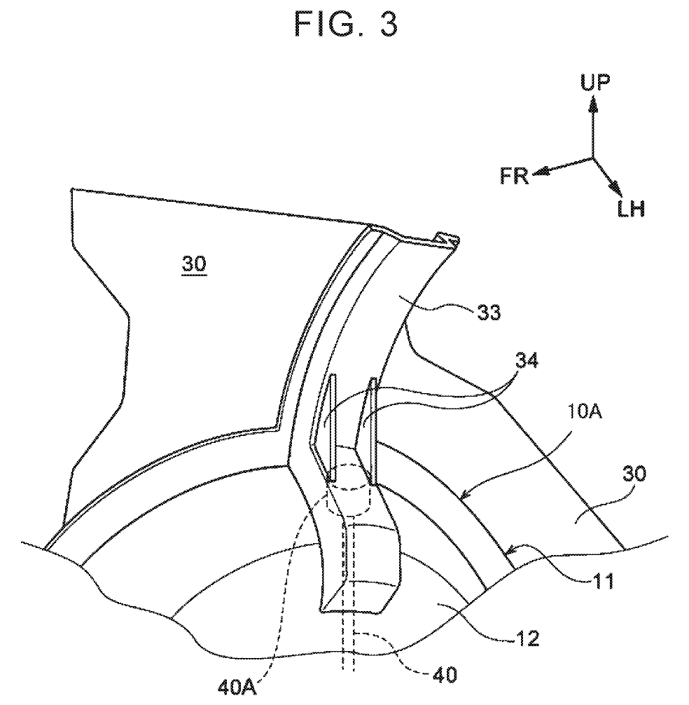

Next, a vehicle rear skeleton structure 10A according to a second embodiment of the present disclosure will be described. In the second embodiment, the same components as those of the vehicle rear skeleton structure 10 of the first embodiment described above are indicated by the same reference numerals, and detailed description thereof will be omitted, and only different components will be described in detail. FIG. 3 is a detailed perspective view of the strainer portion 33 of the vehicle rear skeleton structure 10A according to the second embodiment.

The strainer portion 33 of the vehicle rear skeleton structure 10A of the second embodiment further includes a support portion 34, as shown in FIG. 3, with respect to the strainer portion 13 of the first embodiment described above. The support portion 34 supports the upper end portion 40A of the shock absorber 40 from above via the wheel house portion 12.

Specifically, the support portion 34 is formed in a substantially triangular shape when viewed from the front-rear direction of the vehicle, and the corner portion is disposed in the strainer portion 33 so as to be positioned on the curved portion 33A curved from the upper portion of the wheel house portion 12. That is, one side of the support portion 34 other than the oblique side is joined to the upper portion of the wheel house portion 12, and the other side other than the oblique side is joined to the main body portion 13A of the strainer portion 33. Further, the support portion 34 is provided at a position overlapping with the upper end portion 40A attached to the inner upper portion of the wheel house portion 12 in a top view. That is, the support portion 34 supports the upper end portion 40A of the shock absorber 40 from above via the wheel house portion 12. As an example, the strainer portion 33 of the present embodiment is provided with two support portions 34 having a gap in the vehicle front-rear direction.

The vehicle rear skeleton structure 10A configured as described above is integrally molded by casting including a rear skeleton body portion 11, that is, a pair of left and right wheel house portions 12, a floor portion 14 (a floor base 18, an opening portion 20), a side member portion 16, and a connecting portion 22, a strainer portion 13, and two supporting portions 34.

### Operations and Effects

Next, the operation and effect of the second embodiment will be described.

In the vehicle rear skeleton structure 10A according to the second embodiment, the support portion 34 supports the upper end portion 40A of the shock absorber 40 from above via the wheel house portion 12. Therefore, the input load inputted to the upper end portion of the wheel house portion 12 through the upper end portion 40A of the shock absorber 40 can be distributed and received by the strainer portion 33.

Further, in the present embodiment, since the support portion 34 is joined to the upper portion of the wheel house portion 12 and the main body portion 13A of the strainer portion 33, when the wheel house portion 12 is raised at the time of the rear collision, the upper end of the strainer portion 33 is pushed down the entire wheel house portion 12 by being pushed by the roof side rail 24, it is possible to suppress the raising of the wheel house portion 12. Further, when the upper end of the strainer portion 33 is pushed by the roof side rail 24, it is possible to suppress the strainer portion 33 from being curved in the vehicle vertical direction by the support portion 34, and thus it is possible to increase the rigidity of the strainer portion 33. Accordingly, the rigidity of the entire vehicle rear skeleton structure 10A can be increased.

### Third Embodiment

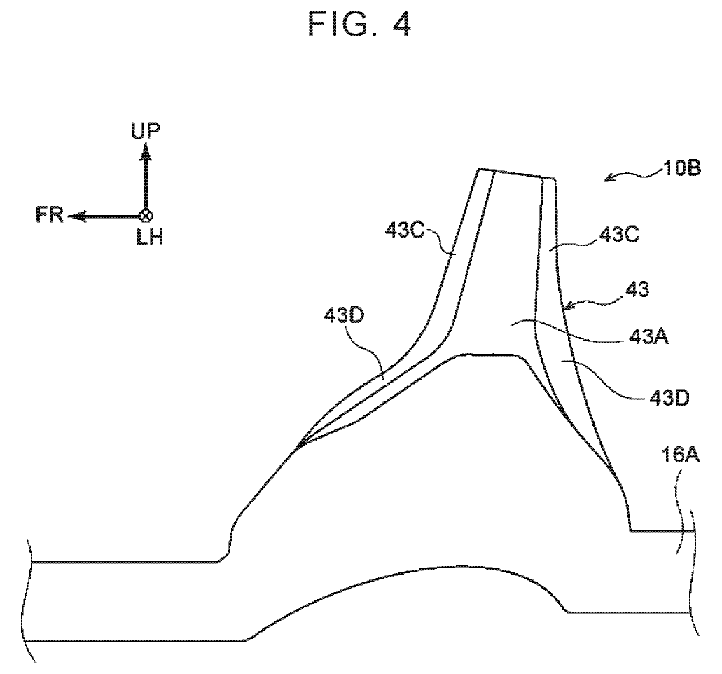

Next, a vehicle rear skeleton structure 10B according to a third embodiment of the present disclosure will be described. In the third embodiment, the same components as those of the vehicle rear skeleton structure 10 of the first embodiment described above are denoted by the same reference numerals, and detailed description thereof is omitted, and only different components will be described in detail. FIG. 4 is a side view schematically showing a vehicle rear skeleton structure 10B according to a third embodiment.

As shown in FIG. 4, both end portions of the strainer portion 43 in the vehicle front-rear direction extend continuously from both end portions of the wheel house portion 12 in the vehicle front-rear direction in the strainer portion 43 of the vehicle rear skeleton structure 10B of the third embodiment. Specifically, as shown in FIG. 4, the strainer portion 43 includes a main body portion 43A that is open on the outer side in the vehicle-width direction and extends upward from the upper portion of the wheel house portion 12.

The main body portion 43A is curved inward in the vehicle-width direction. The main body portion 43A includes a lower flange portion 43C extending in the vehicle front-rear direction from an outer end portion of the main body portion 43A on both sides in the vehicle front-rear direction. The lower flange portion 43C extends below the lower end of the main body portion 43A, and the extended portion 43D is joined to the wheel house portion 12. The extended portion 43D is narrower toward the lower side, and extends to a height in the vicinity of the rear side member portion 16A.

### Operations and Effects

Next, the operation and effect of the third embodiment will be described.

In the vehicle rear skeleton structure 10B according to the third embodiment, since both end portions of the strainer portion 43 in the vehicle front-rear direction extend continuously from both end portions of the wheel house portion 12 in the vehicle front-rear direction, it is possible to smoothly transmit the load between the strainer portion 43 and the wheel house portion 12.

### Supplementary explanation

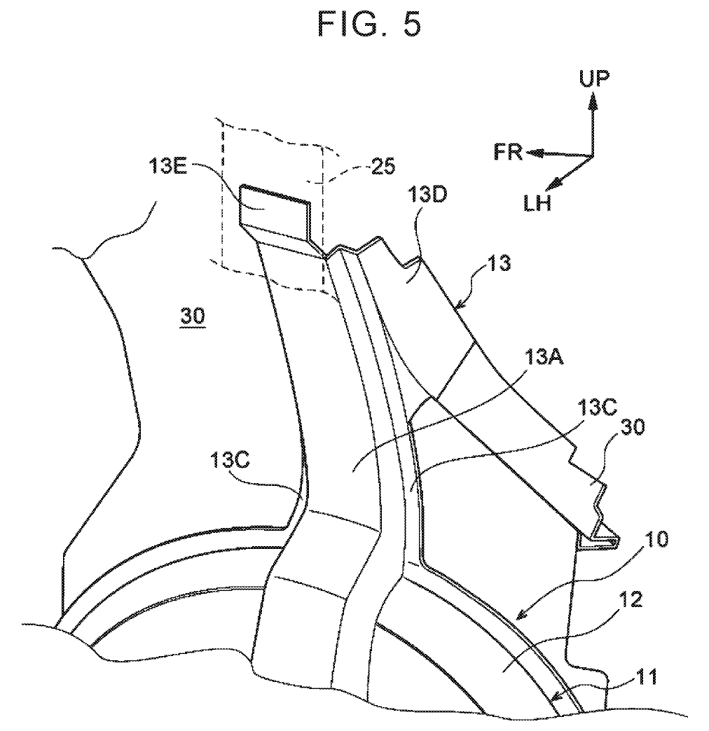

In the above-described embodiment, the upper end of the strainer portion 13, that is, the upper flange portion 13B, is joined to the roof side rail 24, but the present disclosure is not limited thereto. For example, as shown in FIG. 5, the upper end of the strainer portion, i.e., the upper end 13E extending from the main body portion 13A, may be joined to the rear pillar 25.

Further, in the second embodiment described above, the strainer portion 33 includes two support portions 34, but the present disclosure is not limited thereto. The number of the support portions 34 may be one or three or more. Further, the shape of the support portion 34 is not limited to a substantially triangular shape, and may be a substantially quadrangular shape or may be appropriately changed.

Further, the configuration of the present disclosure is not limited to the above-described embodiment, and the configuration can be changed as appropriate as long as the problem can be solved.

What is claimed is:

1. A vehicle rear skeleton structure comprising:
a rear skeleton body portion integrally fabricated by casting and including a wheel house portion; and
a strainer portion integrally fabricated with the rear skeleton body portion and extending from an upper portion of the wheel house portion in a vehicle up-down direction toward a vehicle upper side, an upper end of the strainer portion being joined to a roof side rail or a pillar.

2. The vehicle rear skeleton structure according to claim 1, wherein the strainer portion supports an upper end portion of a shock absorber.

3. The vehicle rear skeleton structure according to claim 1, wherein both end portions of the strainer portion in a vehicle front-rear direction extend continuously from both end portions of the wheel house portion in the vehicle front-rear direction.
